(19) United States
(12) Patent Application Publication
(10) Pub. No.: US 2025/0131339 A1
(43) Pub. Date: Apr. 24, 2025

(54) INFERENCE BY TREE-BASED ENSEMBLE MODELS ON ENCRYPTED DATA

(71) Applicant: International Business Machines Corporation, Armonk, NY (US)

(72) Inventors: Andreea ANGHEL, Adliswil (CH); Thomas PARNELL, Zürich (CH); Charalampos POZIDIS, Thalwil (CH)

(21) Appl. No.: 18/493,409

(22) Filed: Oct. 24, 2023

(51) Int. Cl. G06N 20/20; G06N 5/04; H04L 9/00

(52) U.S. Cl. CPC G06N 20/20; G06N 5/04; H04L 9/008

(57) ABSTRACT

Techniques are provided for inference by tree-based ensemble models on encrypted data. One method includes identifying a plurality of nodes included in a plurality of decision trees of a tree-based ensemble model, and determining, from the plurality of nodes, a first set of nodes where each node represents a unique combination of a feature and a threshold. The method further includes assigning distinct identifiers to the nodes of the first set, identifying a second set of paths included in the plurality of decision trees, and generating an optimized model, where each path of the second set is represented using the distinct identifiers that correspond to the respective nodes along the path, and branch directions taken from the respective nodes.

### BACKGROUND

The present disclosure relates to machine learning inference, and more specifically, to techniques for inference by tree-based ensemble models on encrypted data.

Tree-based ensemble models are widely used in applications involving structured (e.g., tabular) data, such as within the finance, retail, and insurance industries. A tree-based ensemble model may be deployed using a computing device at a network location that is remote from a client, e.g., in the cloud. In some cases, the computing device may not meet one or more trust conditions, such that the tree-based ensemble model and the inference data must remain encrypted when handled by the computing device. However, running machine learning workloads within the encrypted domain tends to be costly and slow, often requiring a time increase of several orders of magnitude when compared to running inference within the plaintext (non-encrypted) domain.

### SUMMARY

According to one embodiment, a method comprises identifying a plurality of nodes included in a plurality of decision trees of a tree-based ensemble model, and determining, from the plurality of nodes, a first set of nodes where each node represents a unique combination of a feature and a threshold. The method further comprises assigning distinct identifiers to the nodes of the first set, identifying a second set of paths included in the plurality of decision trees, and generating an optimized model, where each path of the second set is represented using the distinct identifiers that correspond to the respective nodes along the path, and branch directions taken from the respective nodes.

According to one embodiment, a computer program product comprises a computer-readable storage medium having computer-readable program code embodied therewith. The computer-readable program code is executable by one or more computer processors to perform an operation comprising identifying a plurality of nodes included in a plurality of decision trees of a tree-based ensemble model, and determining, from the plurality of nodes, a first set of nodes where each node represents a unique combination of a feature and a threshold. The operation further comprises assigning distinct identifiers to the nodes of the first set, identifying a second set of paths included in the plurality of decision trees, and generating an optimized model, where each path of the second set is represented using the distinct identifiers that correspond to the respective nodes along the path, and branch directions taken from the respective nodes.

According to one embodiment, a method of securely performing an inference service in an untrusted domain is disclosed. The method comprises receiving data of one or more examples, the data encrypted by a fully homomorphic encryption algorithm. The method further comprises evaluating the data using a tree-based ensemble model, where: each node of the tree-based ensemble model represents a unique combination of a feature and a threshold; each node is assigned a distinct identifier; each path of the tree-based ensemble model is represented using the distinct identifiers that correspond to the respective nodes along the path, and branch directions taken from the respective nodes; and the tree-based ensemble model is encrypted by the fully homomorphic encryption algorithm. The method further comprises generating one or more encrypted scores that are used to determine a final prediction score for the one or more examples.

According to one embodiment, a computer program product comprises a computer-readable storage medium having computer-readable program code embodied therewith. The computer-readable program code is executable by one or more computer processors to perform an operation to provide an inference service in an untrusted domain, the operation comprising receiving data of one or more examples, the data encrypted by a fully homomorphic encryption algorithm. The operation further comprises evaluating the data using a tree-based ensemble model, where each node of the tree-based ensemble model represents a unique combination of a feature and a threshold; each node is assigned a distinct identifier; each path of the tree-based ensemble model is represented using the distinct identifiers that correspond to the respective nodes along the path, and branch directions taken from the respective nodes; and the tree-based ensemble model is encrypted by the fully homomorphic encryption algorithm. The operation further comprises generating one or more encrypted scores that are used to determine a final prediction score for the one or more examples.

### BRIEF DESCRIPTION OF THE DRAWINGS

FIG. 1 illustrates an exemplary system for accelerated inference using a tree-based ensemble model, according to one or more embodiments.

FIG. 2 illustrates an exemplary method of generating an optimized model from a tree-based ensemble model, according to one or more embodiments.

FIG. 3 illustrates an exemplary method of requesting an inference service in an untrusted domain, according to one or more embodiments.

FIG. 4 illustrates decision trees of an exemplary tree-based ensemble model, according to one or more embodiments.

FIG. 5 illustrates node-level optimization of an exemplary tree-based ensemble model, according to one or more embodiments.

FIG. 6 illustrates path-level optimization of an exemplary tree-based ensemble model, according to one or more embodiments.

FIG. 7 illustrates an exemplary method of performing an inference service in an untrusted domain, according to one or more embodiments.

FIG. 8 illustrates an exemplary technique of calculating respective branching scores for each node of an optimized model, according to one or more embodiments.

FIG. 9 illustrates an exemplary technique of generating an encrypted score per path which will be used to determine the prediction label for the example, according to one or more embodiments.

FIG. 10 illustrates an exemplary computing environment for the execution of at least some of the computer code involved in performing the inventive methods, according to one or more embodiments.

### DETAILED DESCRIPTION

Tree-based ensemble models are widely used in applications involving structured (e.g., tabular) data. A tree-based ensemble model generates an inference on inference data (e.g., an input record) by processing a plurality of binary decision trees in parallel, where at each decision tree a comparison operation is performed at each node of the decision tree until a leaf node is reached. The values of the leaf nodes of the plurality of decision trees are combined (e.g., averaging, summing, majority voting) to generate the inference. In an unencrypted domain, each decision tree is ordinarily traversed by performing the comparison operations for the nodes along a single path. However, when operating in an encrypted domain, the result of the comparison operation occurring at each node does not indicate whether to branch to the left or the right (e.g., the correct next step for traversing the decision tree). Consequently, all of the paths and all of the nodes of the decision trees in the encrypted domain must be evaluated, which adds significant time and computational expense.

According to various techniques described herein, inference generation is accelerated by optimizing a tree-based ensemble model to reduce the number of nodes and/or paths within the tree-based ensemble model. The tree-based ensemble model comprises a plurality of decision trees. In some embodiments, a set of nodes is determined from the plurality of nodes of the tree-based ensemble model, where each node of the set represents a unique combination of a feature and a threshold. In some embodiments, the plurality of nodes are quantized to identify one or more duplicate nodes, which are removed when determining the set of nodes. The nodes of the set are assigned distinct identifiers. In some embodiments, a set of paths is identified and an optimized model is generated where each path of the set is represented using the distinct identifiers that correspond to the respective nodes along the path, and branch directions taken from the respective nodes. In some embodiments, each path of the set represents a unique path from a root node to a leaf node of a respective decision tree of the plurality of decision trees.

In some embodiments, the optimized model is encrypted using a fully homomorphic encryption algorithm, and transmitted to a computing device in an untrusted domain. In some embodiments, data of an example is also encrypted using the fully homomorphic encryption algorithm and transmitted with an inference request to the computing device in the untrusted domain. Use of the fully homomorphic encryption algorithm enables the operations of the encrypted optimized model to be performed on the encrypted data without compromising the encryption.

An encrypted single score or multiple scores are received and decrypted to infer a label for the inference example. In some embodiments, an encrypted single score is received that indicates that all the scores associated with the unique paths of the tree-based ensemble model have been calculated and aggregated into a single score. The single score, when decrypted, directly provides the label for the inference example. In these embodiments, the optimized model includes the labels when encrypted and transmitted to the computing device in the untrusted domain.

In other embodiments, a plurality of encrypted scores are received by the computing device in the trusted domain, where each of the plurality of encrypted scores corresponds to a respective path of the unique paths. When the scores are decrypted, the path associated with a score that is closest to zero is indicated as the correct path to provide the label.

Beneficially, by using the optimized model, less time, computational expense, and/or memory are required to generate an inference for the example, as fewer nodes are evaluated. Further, because the nodes found in all paths of the decision trees of the tree-based ensemble model must be evaluated while in the encrypted domain, information about the tree-based ensemble model is protected (compared with other schemes where a single path of each decision tree is evaluated).

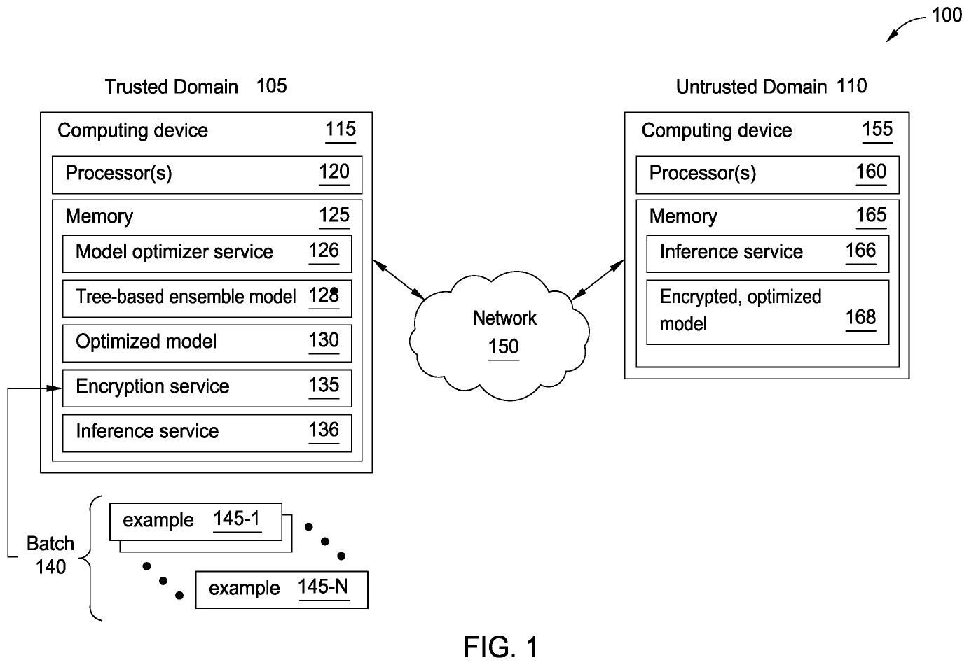

Refer now to FIG. 1, which illustrates an exemplary system 100 for accelerated inference using a tree-based ensemble model, according to one or more embodiments. The system 100 comprises a plurality of computing devices 115, 155 that are communicatively coupled with each other through a network 150.

The network 150 may have any suitable implementation, such as one or more wide area networks (WANs), one or more local access networks (LANs), or combinations thereof. The network 150 comprises infrastructure for communicative capability, such as conductive cabling, wireless transmission, optical transmission, and so forth. The network 150 may further comprise one or more electronic devices providing network functionality and/or services to the network 150, such as routers, firewalls, switches, gateway computers, edge servers, and so forth.

The computing device 115 is included in a trusted domain 105 and the computing device 155 is included in an untrusted domain 110. Generally, the computing device 115 meets a set of one or more trust conditions to be included in the trusted domain 105, while the computing device 155 may not meet the set of one or more trust conditions to be included in the untrusted domain 110. The network 150 may be included fully in the trusted domain 105, fully in the untrusted domain 110, or (as shown) partly in the trusted domain 105 and partly in the untrusted domain 110. Data used to perform the inference service (e.g., a tree-based ensemble model 128 and examples 140-1, . . . , 140-N; discussed in greater detail below) must remain encrypted while transiting the untrusted domain 110, but may be unencrypted while in the trusted domain 105.

The one or more trust conditions may be implemented in any suitable form. In some embodiments, the one or more trust conditions are specified by, or are selected to conform with, data privacy regulations applied to the computing devices 115, 155 (or applied to the entire system 100). In alternate implementations, the computing device 115 owns (or is deemed to own) the data to be used for inference, and the computing device 155 does not meet one or more trust conditions that are specified by the computing device 115. For example, the computing device 155 may reside in a geographic region where data regulations do not permit the inference data to exist in the plaintext domain, or may have a network address that is otherwise excluded by the computing device 115.

In some cases, the computing device 155 is included in the untrusted domain 110 because it has been affirmatively determined to not meet the set of one or more trust conditions. In other cases, the computing device 155 is included in the untrusted domain 110 because it has not been affirmatively determined to meet the set of one or more trust conditions. Stated another way, the state of the computing device 155 is indeterminate as it may or may not meet the set of one or more trust conditions.

The computing device 115 comprises one or more processors 120 and a memory 125. The computing device 115 may be implemented with any suitable form factor, whether relatively static in nature (e.g., mainframe, computer terminal, server, kiosk, workstation) or mobile (e.g., laptop computer, tablet, handheld, smart phone, wearable device). The computing device 115 may be alternately implemented as a plurality of computing devices that are communicatively coupled with each other.

The one or more processors 120 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 125 and controls the operation of the computing device 115.

The one or more processors 120 may include other hardware that operates software to control and process information. The one or more processors 120 executes software stored in the memory 125 to perform any of the functions described herein. The one or more processors 120 control the operation and administration of the computing device 115 by processing information (e.g., information received from input devices and/or communicatively coupled electronic devices).

The memory 125 may store, either permanently or temporarily, data, operational software, or other information for the one or more processors 120. The memory 125 may include any one or a combination of volatile or non-volatile local or remote devices suitable for storing information. For example, the memory 125 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 125, a disk, a CD, or a flash drive. In particular embodiments, the software may include an application executable by the one or more processors 120 to perform one or more of the functions described herein.

In this example, the memory 125 stores a model optimizer service 126 that operates on a tree-based ensemble model 128 to generate an optimized model 130. The tree-based ensemble model 128 comprises a plurality of decision trees, which may be configured for regression or classification tasks. In some embodiments, the plurality of decision trees are binary decision trees. The tree-based ensemble model 128 represents the structure of the plurality of decision trees with any suitable formatting, whether standardized or proprietary. Some non-limiting examples of the format of the tree-based ensemble model 128 include XGBoost in PMML and ONNX, sklearn Random Forest in PMML and ONNX, and LightGBM in PMML, ONNX, and JSON. In some cases, the tree-based ensemble model 128 stores distinct information describing every node and every path within each of the plurality of decision trees, irrespective of whether any nodes or paths within the tree-based ensemble model 128 are redundant. As will be discussed in greater detail below, the model optimizer service 126 reduces the number of nodes and/or paths within the tree-based ensemble model 128 to generate the optimized model 130.

The memory 125 also stores an encryption service 135 that applies a fully homomorphic encryption algorithm to the optimized model 130 and the inference data of inference examples 145-1, . . . , 145-N (also referred to hereafter as “examples”). The data of the examples 145-1, . . . , 145-N may have any suitable formatting. Each example 145-1, . . . , 145-N may alternately be referred to as an “input record” or a “record”. In some embodiments, the examples 145-1, . . . , 145-N are received as a batch 140 at the computing device 115, e.g., from an external computing device 115.

Homomorphic encryption converts plaintext data into ciphertext data on which mathematical operations may be performed, as if in the plaintext form, without compromising the encryption. More generally, “homomorphic” describes transformation of one data set into another while preserving relationships between elements in both sets. Because the relational structure of the data is maintained, a mathematical operation will generate equivalent results irrespective of whether the data is encrypted. A “fully homomorphic encryption” algorithm preserves at least addition and multiplication operations, which can be used in combination to perform arbitrary functions on the data. Some non-limiting examples of the fully homomorphic encryption algorithm include the Brakerski-Fan-Vercauteren (BFV) scheme (suitable for integer arithmetic) and the Cheon-Kim-Kim-Song (CKKS) scheme (suitable for approximating floating-point arithmetic, and relatively efficient for batch data).

The memory 125 also stores an inference service 136 that generates inference requests for the examples 145-1, . . . , 145-N. The inference service 136 transmits inference request(s), including the encrypted data of the examples 145-1, . . . , 145-N, to the computing device 155 via the network 150. In some embodiments, the inference service 136 also transmits the optimized model 130 (when encrypted) to the computing device 155 via the network 150, which in some cases may be prior to transmitting the inference request(s).

The computing device 155 comprises one or more processors 160 and a memory 165. Similar to the discussion of the computing device 115 above, the computing device 155 may be implemented with any suitable form factor, and may be alternately implemented as a plurality of computing devices that are communicatively coupled with each other. Similar to the discussion of the one or more processors 120 above, the one or more processors 160 are any electronic circuitry that is communicatively coupled to the memory 165 and controls the operation of the computing device 155 (in some cases, by operating software to control and process information).

Similar to the discussion of the memory 125 above, the memory 165 may store, either permanently or temporarily, data, operational software, or other information for the one or more processors 160, and may include any one or a combination of volatile or non-volatile local or remote devices suitable for storing information.

The memory 165 comprises an inference service 166 that receives encrypted data of the plurality of examples 145-1, . . . , 145-N, evaluates each of the examples 145-1, . . . , 145-N using an encrypted tree-based ensemble model, and generates one or more encrypted scores that are used to infer a final prediction score for the example in plaintext. The inference service 166 may be implemented as a software application that is executed by the one or more processors 160.

In some embodiments, the encrypted tree-based ensemble model is an encrypted, optimized model 168 that is received from the computing device 115 of the trusted domain 105. In some embodiments, the encrypted score that indicates which path is correct for the example 145-1, . . . , 145-N is included in a plurality of encrypted scores that are generated by the inference service 166, where the plurality of encrypted scores correspond to the distinct paths included in the encrypted, optimized model 168. The inference service 166 transmits, via the network 150, the plurality of encrypted scores to the inference service 136 of the computing device 115.

In some embodiments, the inference service 166 generates a single encrypted score that indicates to the inference service 136 of the computing device 115 that all the scores associated with the unique paths of the encrypted tree-based ensemble model have been calculated and aggregated into a single score. The single score, when decrypted by the inference service 136, directly provides the label for the inference example. In these embodiments, the optimized model includes the labels when encrypted and transmitted to the computing device 155.

In other embodiments, the inference service 166 generates a plurality of encrypted scores that each correspond to a respective path of the unique paths. When the scores are decrypted, the inference service 136 determines that the path associated with a score that is closest to zero is the correct path to provide the label for the example.

In some embodiments, the inference service 136 of the computing device 115 uses the encryption service 135 to decrypt the plurality of encrypted scores, and determines a score, of the plurality of decrypted scores, that is closest to zero to infer a label corresponding to the example 145-1, . . . , 145-N. In some embodiments, the inference service 136 determines a score that is closest to zero for each of the decision trees included in the tree-based ensemble model 128, indicating which paths of the decision trees are correct. The inference service 136 infers a label for the example 145-1, . . . , 145-N using the indicated correct paths for the tree-based ensemble model 128.

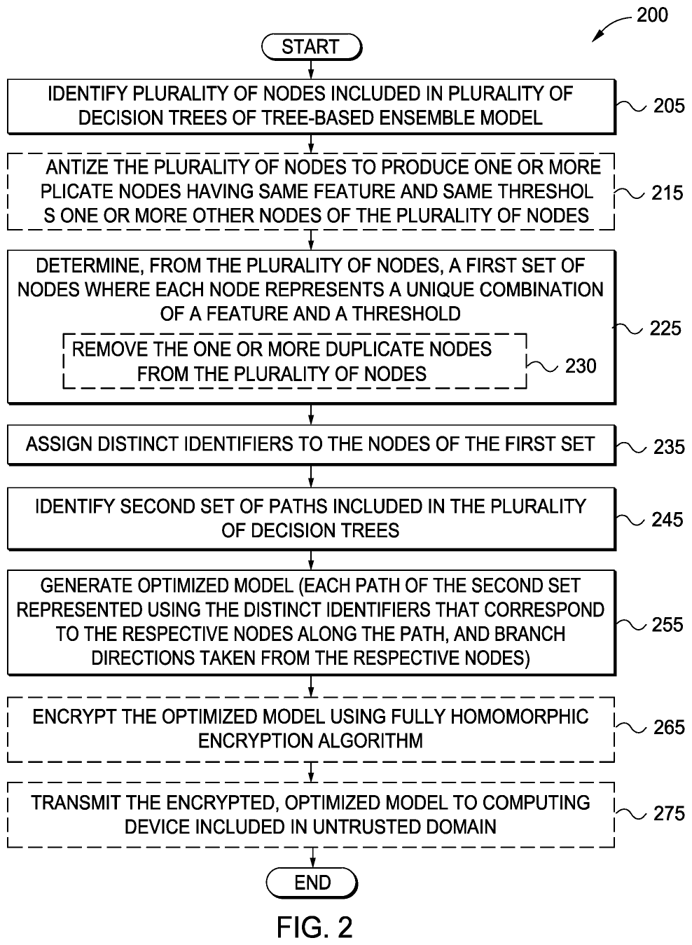

FIG. 2 illustrates an exemplary method 200 of generating an optimized model from a tree-based ensemble model, according to one or more embodiments. The method 200 may be used in conjunction with other embodiments described herein. For example, the method 200 may be performed by various components of the computing device 115 in the trusted domain 105 (e.g., by the model optimizer service 126, the encryption service 135, and/or the inference service 136 of FIG. 1).

The method 200 begins at block 205, where the model optimizer service 126 identifies a plurality of nodes included in a plurality of decision trees of a tree-based ensemble model. The tree-based ensemble model represents the structure of the plurality of decision trees with any suitable formatting, whether standardized or proprietary. In some cases, the tree-based ensemble model stores distinct information describing every node and every path within each of the plurality of decision trees, irrespective of whether any nodes or paths within the tree-based ensemble model are redundant.

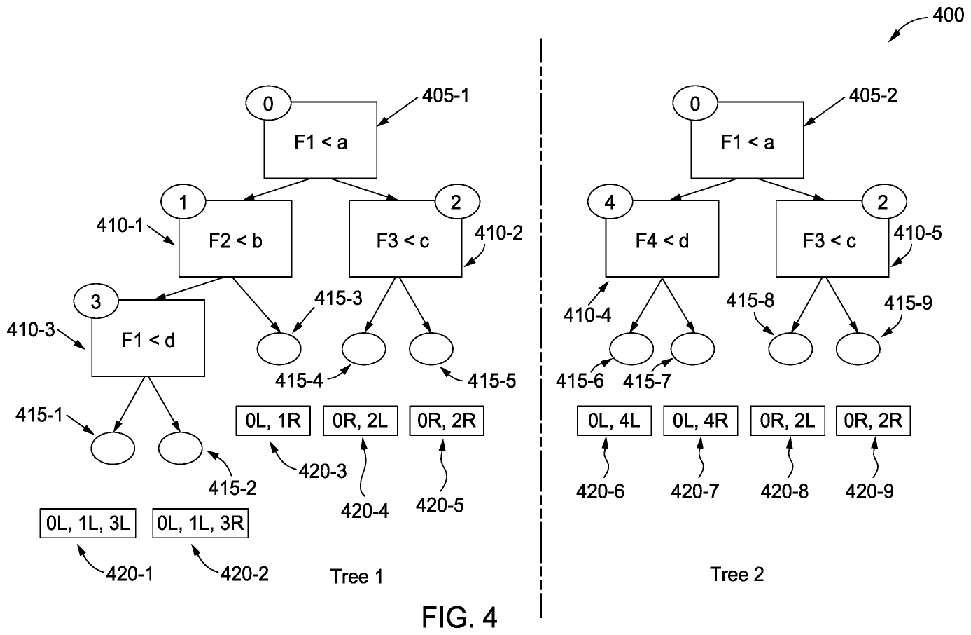

Refer also to FIG. 4, which illustrates decision trees of an exemplary tree-based ensemble model, according to one or more embodiments. While diagram 400 illustrates two (2) decision trees Tree 1, Tree 2 for simplicity of the example, other numbers of decision trees of a tree-based ensemble model are also contemplated. The model optimizer service 126 identifies the nodes of Tree 1: a root node 405-1, intermediate nodes 410-1, 410-2, 410-3, and leaf nodes 415-1, . . . , 415-5. The model optimizer service 126 identifies the nodes of Tree 2: a root node 405-2, intermediate nodes 410-4, 410-5, and leaf nodes 415-6, . . . , 415-9. Each of the root nodes 405-1, 405-2 and the intermediate nodes 410-1, . . . , 410-5 has a respective comparison operation to be performed, and each of the leaf nodes 415-1, . . . , 415-9 has a respective label. Each comparison operation has a respective combination of a feature and a threshold.

At optional block 215, the model optimizer service 126 quantizes the plurality of nodes to produce one or more duplicate nodes having a same feature and a same threshold as one or more other nodes of the plurality of nodes. In some embodiments, the model optimizer service 126 builds feature histograms to reduce the complexity of searching for optimal splits for the nodes of the decision trees. Building such feature histograms are typically seen in the context of boosting machines and will be understood by the person of ordinary skill in the art. In some embodiments, threshold values of the nodes of the decision trees and/or values of the examples 145-1, . . . , 145-N are mapped to a number of histogram bins.

In the diagram 400, the root nodes 405-1, 405-2 both have a same comparison operation: feature F1 is less than a threshold “a” (F1<a). The comparison operation of the intermediate node 410-1 is a feature F2 less than a threshold “b” (F2<b). The comparison operation of the intermediate nodes 410-2, 410-5 is a feature F3 less than a threshold “c” (F3<c). The comparison operation of the intermediate node 410-3 is the feature F1 less than a threshold “d” (F1<d). The comparison operation of the intermediate node 410-4 is a feature F4 less than the threshold “d” (F4<d). In this example, the root nodes 405-1, 405-2 are “duplicate” nodes sharing a same comparison operation, and the intermediate nodes 410-2, 410-5 are duplicate nodes sharing a same comparison operation. In some embodiments, some or all of the values of the thresholds “a”, . . . , “d” may be selected based on the quantization of the optional block 215. In other embodiments, some or all of the values of the thresholds “a”, . . . , “d” may be determined as optimal splits for the respective nodes.

Returning to FIG. 2, at block 225, the model optimizer service 126 determines, from the plurality of nodes, a first set of nodes where each node represents a unique combination of a feature and a threshold. In some embodiments, some or all of the thresholds correspond to the histogram bins of the optional block 215. In some embodiments, block 225 includes an optional block 230, where the model optimizer service 126 removes the one or more duplicate nodes from the plurality of nodes in determining the first set of nodes.

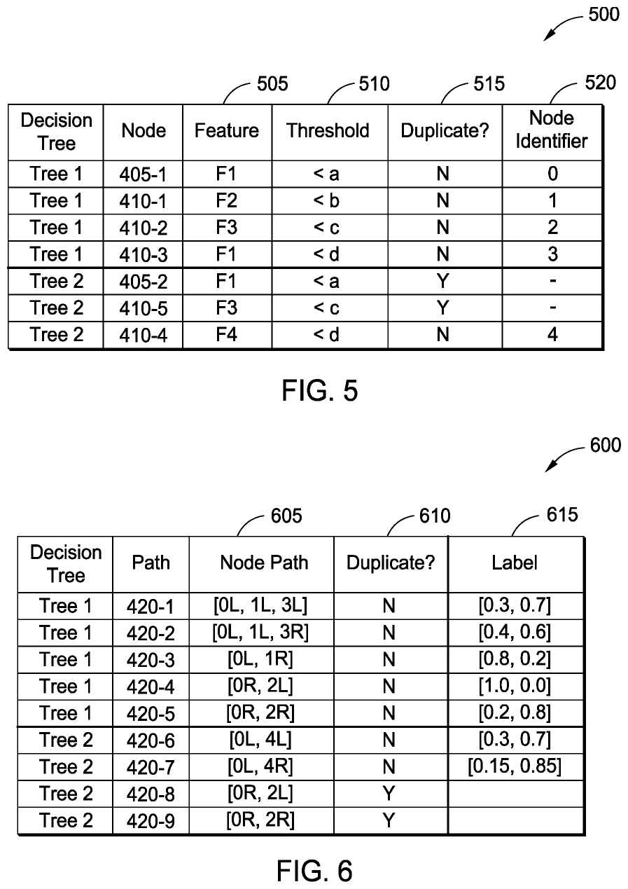

Refer also to FIG. 5, which illustrates node-level optimization of an exemplary tree-based ensemble model, according to one or more embodiments. Table 500 of FIG. 5 includes the plurality of nodes included in the decision trees Tree 1, Tree 2, and illustrates representative operation of the model optimizer service 126. The table 500 includes a Feature field 505, a Threshold field 510, a Duplicate field 515, and a Node Identifier field 520. Notably, all of the values of the Feature field 505 and the Threshold field 510 corresponding to the nodes 405-1, 405-2, 410-1, . . . , 410-5 are encrypted.

The model optimizer service 126 assesses the nodes 405-1, 405-2, 410-1, . . . , 410-5 to identify any nodes having a same value in the Feature field 505 and a same value in the Threshold field 510. As discussed above, the root nodes 405-1, 405-2 are duplicate nodes sharing a same value in the Feature field 505 (that is, feature F1) and a same value in the Threshold field 510 (that is, <a), and the intermediate nodes 410-2, 410-5 are duplicate nodes sharing a same value in the Feature field 505 (that is, feature F3) and a same value in the Threshold field 510 (that is, <c). As shown, the model optimizer service 126 identifies the nodes 405-2, 410-5 as the duplicate nodes (Duplicate field 515: “Y”), although one or both of the nodes 405-1, 405-2 may alternately be identified as the duplicate nodes.

Thus, the first set of nodes determined by the model optimizer service 126 is those nodes of the plurality of nodes identified as being non-duplicate nodes (Duplicate field 515: “N”). More specifically, the first set of nodes is the nodes 405-1, 410-1, 410-2, 410-3 from Tree 1, and the node 410-4 from Tree 2. Beneficially, by reducing the number of nodes in this way, the runtime of the inference service 166 to generate an inference on examples is reduced by requiring fewer comparison operations, and is further reduced as the inference is more suitable for parallel computation by the one or more processors 160 of the computing device 155. The inference service 166 may further exhibit a greater throughput, a lesser processing and/or memory requirement, and/or a lesser energy consumption.

Returning to FIG. 2, at block 235, the model optimizer service 126 assigns distinct identifiers to the nodes of the first set. The distinct identifiers may be provided in any suitable form, such as sequential numbers, arbitrarily assigned values, coded values, and so forth. According to the Node Identifier field 520 of FIG. 5, the model optimizer service 126 assigns node identifier “0” to the node 405-1, “1” to the node 410-1, “2” to the node 410-2, “3” to the node 410-3, and “4” to the node 410-4.

At block 245, the model optimizer service 126 identifies a second set of paths included in the plurality of decision trees. Each path extends from a root node to a leaf node of a respective decision tree of the plurality of decision trees. Each path is represented using the distinct identifiers that correspond to the respective nodes along the path, and branch directions taken from the respective nodes. As shown, Tree 1 includes paths 420-1, . . . , 420-5 and Tree 2 includes paths 420-6, . . . , 420-9.

Refer also to FIG. 6, which illustrates path-level optimization of an exemplary tree-based ensemble model, according to one or more embodiments. Table 600 of FIG. 6 includes the plurality of paths 420-1, . . . , 420-9 included in the decision trees Tree 1, Tree 2, and illustrates representative operation of the model optimizer service 126. The table 600 includes a Node Path field 605, a Duplicate field 610, and a Label field 615.

The model optimizer service 126 determines a node path for each of the paths 420-1, . . . , 420-9, where each path is represented using the distinct identifiers that correspond to the respective nodes along the path, and branch directions taken from the respective nodes. As shown, the possible branch directions from each node are left (“L”) and right (“R”), but other implementations of the branch directions are also contemplated.

According to the table 600, the value of the Node Path field 605 for the path 420-1 is [0L, 1L, 3L], indicating that the path 420-1 begins at a root node with the node identifier “0”, branches to the left (“L”) to an intermediate node with the node identifier “1”, branches to the left (“L”) to an intermediate node with the node identifier “3”, and branches to the left (“L”) to a leaf node. The value of the Node Path field 605 for the path 420-2 is [0L, 1L, 3R], for the path 420-3 is [0L, 1R], for the path 420-4 is [0R, 2L], for the path 420-5 is [0R, 2R], for the path 420-6 is [0L, 4L], for the path 420-7 is [0L, 4R], for the path 420-8 is [0R, 2L], and for the path 420-9 is [0R, 2R].

In some embodiments, the model optimizer service 126 includes all of the paths 420-1, . . . , 420-9 in the identified second set of paths. In other embodiments, the model optimizer service 126 performs path-level optimization of the tree-based ensemble model, which may be in conjunction with the node-level optimization discussed above with respect to FIG. 5.

The model optimizer service 126 assesses the paths 420-1, . . . , 420-9 to identify any paths having a same value in the Node Path field 605. As discussed above, the paths 420-4, 420-8 are duplicate paths sharing a same value in the Node Path field 605 (that is, [0R, 2L]), and the paths 420-5, 420-9 are duplicate paths sharing a same value in the Node Path field 605 (that is, [0R, 2R]). As shown, the model optimizer service 126 identifies the paths 420-8, 420-9 as the duplicate paths (Duplicate field 610: “Y”), although one or both of the paths 420-4, 420-5 may alternately be identified as the duplicate paths.

Thus, when performing path-level optimization, the second set of paths determined by the model optimizer service 126 is those paths of the plurality of paths identified as being non-duplicate paths (Duplicate field 610: “N”). Stated another way, one or more duplicate paths are removed from the plurality of paths 420-1, . . . , 420-9 to determine the second set of paths, such that each path of the second set represents a unique path from a root node to a leaf node of a respective decision tree of the plurality of decision trees. More specifically, the second set of paths is the paths 420-1, . . . , 420-5 from Tree 1, and paths 420-6, 420-7 from Tree 2. Beneficially, by reducing the number of paths in this way, the runtime of the inference service 166 to generate an inference on examples is reduced by requiring fewer comparison operations. The inference service 166 may further exhibit a greater throughput, a lesser processing and/or memory requirement, and/or a lesser energy consumption.

Returning to FIG. 2, at block 255, the model optimizer service 126 generates an optimized model, where each path of the second set is represented using the distinct identifiers that correspond to the respective nodes along the path, and branch directions taken from the respective nodes. Using the example shown in FIG. 6, the model optimizer service 126 generates the optimized model using the values of the Node Path field 605 for the second set of paths.

At block 255, the model optimizer service 126 generates an optimized model, where each path of the second set is represented using the distinct identifiers that correspond to the respective nodes along the path, and branch directions taken from the respective nodes.

At optional block 265, the encryption service 135 encrypts the optimized model using a fully homomorphic encryption algorithm. At optional block 275, the inference service 136 transmits the encrypted, optimized model to a computing device included in an untrusted domain. The method 200 ends following completion of block 275.

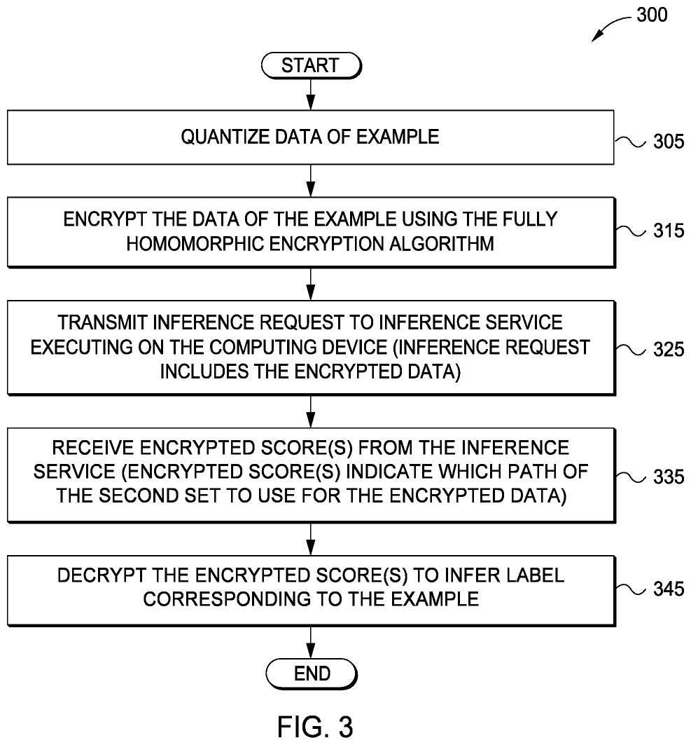

FIG. 3 illustrates an exemplary method 300 of requesting an inference service in an untrusted domain, according to one or more embodiments. The method 300 may be used in conjunction with other embodiments described herein. For example, the method 300 may be performed by various components of the computing device 115 in the trusted domain 105 (e.g., by the encryption service 135 and/or the inference service 136).

The method 300 begins at optional block 305, where the model optimizer service 126 quantizes data of an example for an inference. In some embodiments, the model optimizer service 126 performs a same quantization process as that performed for the plurality of nodes of the tree-based ensemble model (e.g., mapping the data to the same histogram bins as used for determining threshold values).

At block 315, the encryption service 135 encrypts the data of the example using the fully homomorphic encryption algorithm. At block 325, the inference service 136 transmits an inference request to an inference service 166 executing on a computing device 155 in an untrusted domain 110, where the inference request includes the encrypted data.

At block 335, the inference service 136 receives an encrypted score from the inference service 166 executing on the computing device 155 in the untrusted domain 110, where the encrypted score indicates which path of the second set to use for the encrypted data. In some embodiments, the encrypted score is included in a plurality of encrypted scores that are generated by the inference service 166 corresponding to the distinct paths included in the encrypted, optimized model 168.

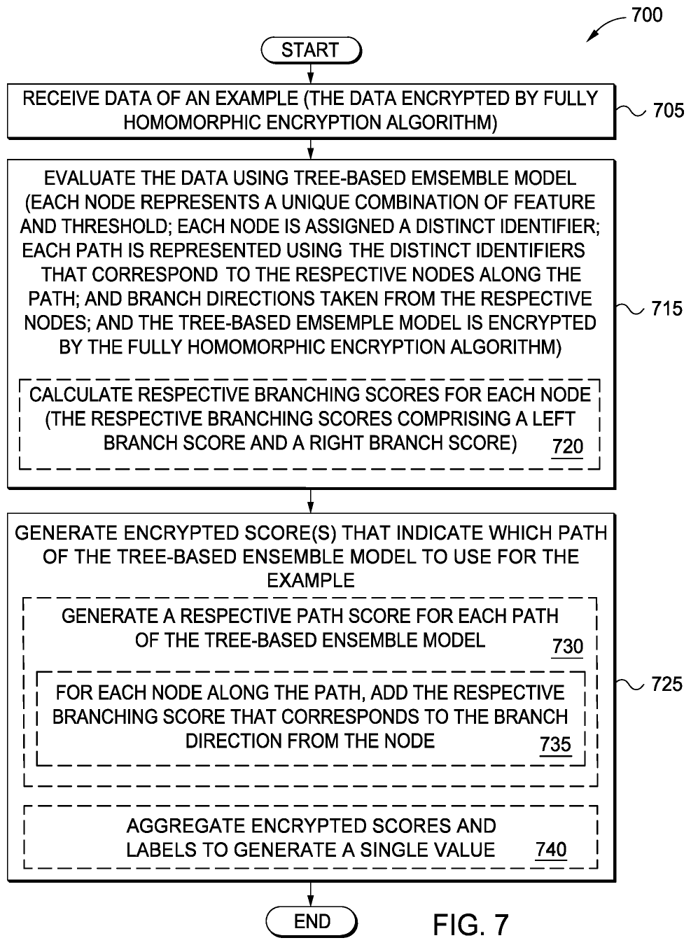

Exemplary techniques for generating encrypted scores will now be discussed with respect to FIGS. 7-9 and the subsequent clauses. FIG. 7 illustrates an exemplary method 700 of performing an inference service in an untrusted domain, according to one or more embodiments. The method 700 may be used in conjunction with other embodiments described herein. For example, the method 700 may be performed by the inference service 166 of the computing device 155 in the untrusted domain 110.

The method 700 begins at block 705, where the inference service 166 receives data of an example, where the data is encrypted by a fully homomorphic encryption algorithm. At block 715, the inference service 166 evaluates the data using a tree-based ensemble model. The tree-based ensemble model is encrypted by the fully homomorphic encryption algorithm. In the tree-based ensemble model, each node represents a unique combination of a feature and a threshold, each node is assigned a distinct identifier, each path is represented using the distinct identifiers that correspond to the respective nodes along the path, and branch directions taken from the respective nodes.

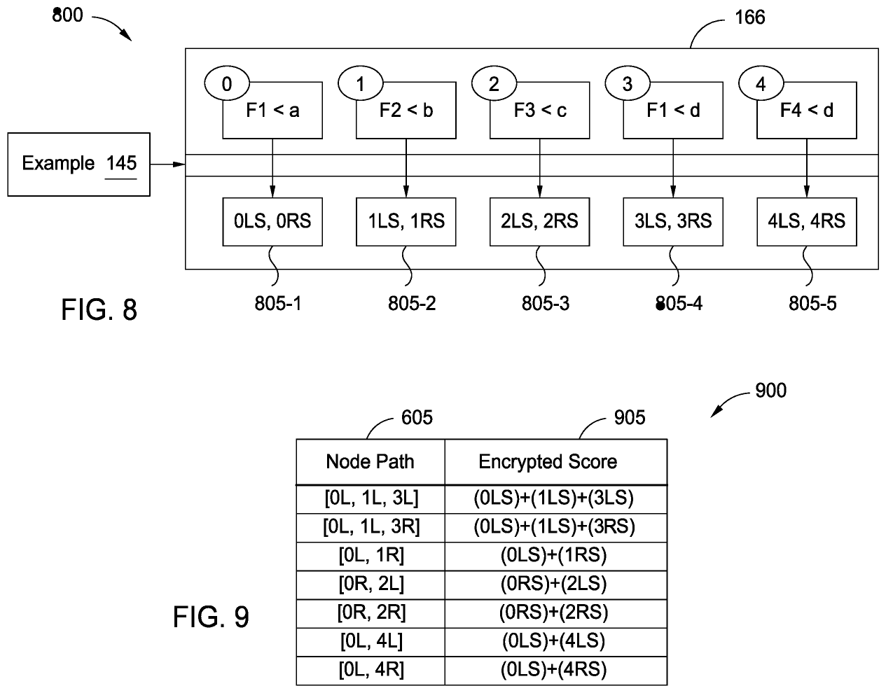

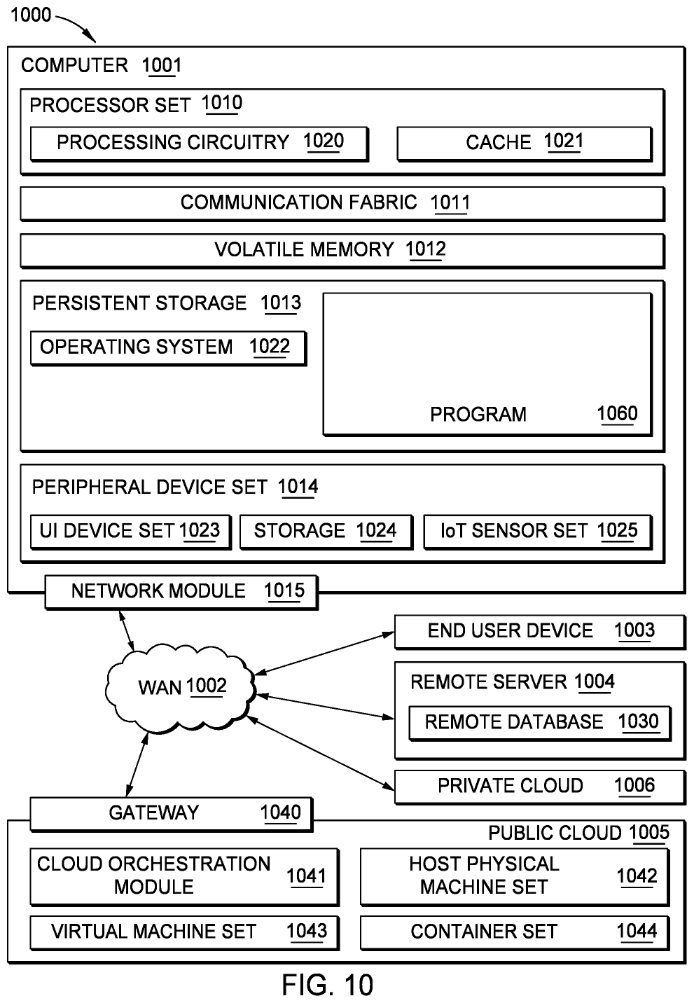

In some embodiments, the block 715 comprises optional block 720, where the inference service 166 calculates branching scores for each node. In some embodiments, the respective branching scores comprise a left branch score and a right branch score. Refer also to FIG. 8, which illustrates an exemplary technique of calculating respective branching scores for each node of an optimized model, according to one or more embodiments. In diagram 800, the inference service 166 receives encrypted data of an example 145, and applies the comparison operations of each of the nodes of the first set (that is, node identifiers “0”, . . . , “4”) to the encrypted data. As the correct branching directions from the various comparison operations cannot be determined in the encrypted domain, the inference service 166 determines both a left branch score and a right branch for each of the nodes of the first set. For example, the branching scores 805-1 for the node identifier “0” are determined as “0LS” for the left branch score, and “0RS” for the right branch score, the branching scores 805-2 for the node identifier “1” are determined as “1LS” and “1RS”, the branching scores 805-3 for the node identifier “2” are determined as “2LS” and “2RS”, the branching scores 805-4 for the node identifier “3” are determined as “3LS” and “3RS”, and the branching scores 805-5 for the node identifier “4” are determined as “4LS” and “4RS”.

At block 725, the inference service 166 generates one or more encrypted scores that are used to determine a final prediction score for the one or more examples. In some embodiments, the block 725 comprises an optional block 730, where the inference service 166 generates a respective path score for each path of the tree-based ensemble model. In some embodiments, the optional block 730 comprises an optional block 735, where the inference service 166 adds, for each node along the path, the respective branching score that corresponds to the branch direction from the node.

Refer also to FIG. 9, which illustrates an exemplary technique of generating an encrypted score per path which will be used to determine the prediction label for the example, according to one or more embodiments. The table 900 includes a Node Path field 605 and an Encrypted Score field 905. The inference service 166 adds, for each node along the node path, the respective branching score that corresponds to the branch direction from the node. Thus, for the node path [0L, 1L, 3L], the value for the Encrypted Score field 905 is (0LS)+(1LS)+(3LS), for the node path [0L, 1L, 3R], the value for the Encrypted Score field 905 is (0LS)+(1LS)+(3RS), and so forth.

At an optional block 740, the inference service 166 aggregates a plurality of encrypted scores and labels to generate a single value, which is returned as the encrypted score to the inference service 136. In this embodiment, the optimized model includes the labels when encrypted and transmitted to the inference service 136. The method 700 ends following completion of block 725.

Now returning to FIG. 3, at block 345, the encryption service 135 decrypts the one or more encrypted score(s) to infer a label corresponding to the example. In some embodiments, the inference service 136 of the computing device 115 uses the encryption service 135 to decrypt the plurality of encrypted scores, and determines a score, of the plurality of decrypted scores, that is closest to zero to infer a label corresponding to the example. In some embodiments, the inference service 136 determines a score that is closest to zero for each of the decision trees included in the tree-based ensemble model, indicating which paths of the decision trees are correct. The inference service 136 infers a label for the example using the indicated correct paths for the tree-based ensemble model. For example, assuming the node path [0L, 1L, 3L] yields the lowest encrypted score of all the node paths, the inference service 136 accesses the Label field 615 of Table 600 to infer the label of the example as [0.3, 0.7]. The method 300 ends following completion of block 345.

Several exemplary clauses will now be described:

Clause 1. A method of securely performing an inference service in an untrusted domain, the method comprising:
receiving data of one or more examples, the data encrypted by a fully homomorphic encryption algorithm;
evaluating the data using a tree-based ensemble model, where:
   each node of the tree-based ensemble model represents a unique combination of a feature and a threshold;
   each node is assigned a distinct identifier;
   each path of the tree-based ensemble model is represented using the distinct identifiers that correspond to the respective nodes along the path, and branch directions taken from the respective nodes; and
   the tree-based ensemble model is encrypted by the fully homomorphic encryption algorithm; and
generating one or more encrypted scores that are used to determine a final prediction score for the one or more examples.
   Clause 2. The method of clause 1, the one or more encrypted scores to be decrypted by a computing device included in a trusted domain to infer one or more labels corresponding to the one or more examples.
   Clause 3. The method of clause 1, wherein each path of the tree-based ensemble model represents a unique path from a root node to a leaf node of a respective decision tree of a plurality of decision trees of the tree-based ensemble model.
   Clause 4. The method of clause 1, wherein evaluating the data using the tree-based ensemble model comprises:
calculating respective branching scores for each node, the respective branching scores comprising a left branch score and a right branch score.
   Clause 5. The method of clause 4, wherein generating the one or more encrypted scores comprises:
generating a respective path score for each path of the tree-based ensemble model, wherein generating the respective path score comprises:
   for each node along the path, adding the respective branching score that corresponds to the branch direction from the node.
      Clause 6. The method of clause 5, wherein the encrypted score, of the one or more encrypted scores, that indicates which path to use for the example is the path score having the value closest to zero.
      Clause 7. A computer program product comprising:
a computer-readable storage medium having computer-readable program code embodied therewith, the computer-readable program code executable by one or more computer processors to perform an operation to provide an inference service in an untrusted domain, the operation comprising:
   receiving data of one or more examples, the data encrypted by a fully homomorphic encryption algorithm;
   evaluating the data using a tree-based ensemble model, where:
      each node of the tree-based ensemble model represents a unique combination of a feature and a threshold;
      each node is assigned a distinct identifier;
      each path of the tree-based ensemble model is represented using the distinct identifiers that correspond to the respective nodes along the path, and branch directions taken from the respective nodes; and
      the tree-based ensemble model is encrypted by the fully homomorphic encryption algorithm; and
generating one or more encrypted scores that are used to determine a final prediction score for the one or more examples.
   Clause 8. The computer program product of clause 7, the one or more encrypted scores to be decrypted by a computing device included in a trusted domain to infer one or more labels corresponding to the one or more examples.
   Clause 9. The computer program product of clause 7, wherein each path of the tree-based ensemble model represents a unique path from a root node to a leaf node of a respective decision tree of a plurality of decision trees of the tree-based ensemble model.
   Clause 10. The computer program product of clause 7, wherein evaluating the data using the tree-based ensemble model comprises:
calculating respective branching scores for each node, the respective branching scores comprising a left branch score and a right branch score.
   Clause 11. The computer program product of clause 10, wherein generating the one or more encrypted scores comprises:
generating a respective path score for each path of the tree-based ensemble model, wherein generating the respective path score comprises:
   for each node along the path, adding the respective branching score that corresponds to the branch direction from the node.
      Clause 12. The computer program product of clause 11, wherein the encrypted score, of the one or more encrypted scores, that indicates which path to use for the example is the path score having the value closest to zero.
      Clause 13. A system of securely performing an inference service in an untrusted domain, the system comprising:
a memory storing a tree-based ensemble model, where:
   each node of the tree-based ensemble model represents a unique combination of a feature and a threshold;
   each node is assigned a distinct identifier;
   each path of the tree-based ensemble model is represented using the distinct identifiers that correspond to the respective nodes along the path, and branch directions taken from the respective nodes; and
   the tree-based ensemble model is encrypted by a fully homomorphic encryption algorithm; and
one or more processors to:
   receive data of one or more examples, the data encrypted by the fully homomorphic encryption algorithm;
   evaluate the data using the tree-based ensemble model; and
   generate one or more encrypted scores that are used to determine a final prediction score for the one or more examples.
      Clause 14. The system of clause 13, the one or more encrypted scores to be decrypted by a computing device included in a trusted domain to infer one or more labels corresponding to the one or more examples.
      Clause 15. The system of clause 13, wherein each path of the tree-based ensemble model represents a unique path from a root node to a leaf node of a respective decision tree of a plurality of decision trees of the tree-based ensemble model.
      Clause 16. The system of clause 13, wherein evaluating the data using the tree-based ensemble model comprises:
calculating respective branching scores for each node, the respective branching scores comprising a left branch score and a right branch score.
   Clause 17. The system of clause 16, wherein generating the one or more encrypted scores comprises:
generating a respective path score for each path of the tree-based ensemble model, wherein generating the respective path score comprises:
   for each node along the path, adding the respective branching score that corresponds to the branch direction from the node.
      Clause 18. The system of clause 17, wherein the encrypted score, of the one or more encrypted scores, that indicates which path to use for the example is the path score having the value closest to zero.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as block 1060 (e.g., the encryption service 135 and the inference service 136 of FIG. 1). In addition to block 1060, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1060, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 1. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 200 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

While the foregoing is directed to embodiments of the present invention, other and further embodiments of the invention may be devised without departing from the basic scope thereof, and the scope thereof is determined by the claims that follow.

What is claimed is:

1. A method comprising:
identifying a plurality of nodes included in a plurality of decision trees of a tree-based ensemble model;
determining, from the plurality of nodes, a first set of nodes where each node represents a unique combination of a feature and a threshold;
assigning distinct identifiers to the nodes of the first set;
identifying a second set of paths included in the plurality of decision trees; and
generating an optimized model, where each path of the second set is represented using the distinct identifiers that correspond to the respective nodes along the path, and branch directions taken from the respective nodes.

2. The method of claim 1, wherein each path of the second set represents a unique path from a root node to a leaf node of a respective decision tree of the plurality of decision trees.

3. The method of claim 1, wherein determining the first set of nodes comprises:
removing one or more duplicate nodes, from the plurality of nodes, having a same feature and a same threshold as one or more other nodes of the plurality of nodes.

4. The method of claim 3, further comprising:
quantizing, prior to determining the first set of nodes, the plurality of nodes to produce the one or more duplicate nodes.

5. The method of claim 1, further comprising:
encrypting the optimized model using a fully homomorphic encryption algorithm; and
transmitting the encrypted, optimized model to a computing device included in an untrusted domain.

6. The method of claim 5, further comprising:
encrypting data of one or more examples using the fully homomorphic encryption algorithm;
transmitting an inference request to an inference service executing on the computing device, the inference request including the encrypted data;
receiving one or more encrypted scores from the inference service corresponding to the one or more examples, each of the one or more encrypted scores indicating which path of the second set to use for the respective example; and
decrypting the one or more encrypted scores to infer one or more labels corresponding to the one or more examples.

7. The method of claim 6, further comprising:
quantizing the data of the one or more examples prior to encrypting the data.

8. A computer program product comprising:
a computer-readable storage medium having computer-readable program code embodied therewith, the computer-readable program code executable by one or more computer processors to perform an operation comprising:
identifying a plurality of nodes included in a plurality of decision trees of a tree-based ensemble model;
determining, from the plurality of nodes, a first set of nodes where each node represents a unique combination of a feature and a threshold;
assigning distinct identifiers to the nodes of the first set;
identifying a second set of paths included in the plurality of decision trees; and
generating an optimized model, where each path of the second set is represented using the distinct identifiers that correspond to the respective nodes along the path, and branch directions taken from the respective nodes.

9. The computer program product of claim 8, wherein each path of the second set represents a unique path from a root node to a leaf node of a respective decision tree of the plurality of decision trees.

10. The computer program product of claim 8, wherein determining the first set of nodes comprises:
removing one or more duplicate nodes, from the plurality of nodes, having a same feature and a same threshold as one or more other nodes of the plurality of nodes.

11. The computer program product of claim 10, the operation further comprising:
quantizing, prior to determining the first set of nodes, the plurality of nodes to produce the one or more duplicate nodes.

12. The computer program product of claim 8, the operation further comprising:
encrypting the optimized model using a fully homomorphic encryption algorithm; and
transmitting the encrypted, optimized model to a computing device included in an untrusted domain.

13. The computer program product of claim 12, the operation further comprising:
encrypting data of one or more examples using the fully homomorphic encryption algorithm;
transmitting an inference request to an inference service executing on the computing device, the inference request including the encrypted data;
receiving one or more encrypted scores from the inference service corresponding to the one or more examples, each of the one or more encrypted scores indicating which path of the second set to use for the respective example; and
decrypting the one or more encrypted scores to infer one or more labels corresponding to the one or more examples.

14. The computer program product of claim 13, the operation further comprising:
quantizing the data of the one or more examples prior to encrypting the data.

15. A system comprising:
a memory storing a tree-based ensemble model; and
one or more processors to:
identify a plurality of nodes included in a plurality of decision trees of the tree-based ensemble model;
determine, from the plurality of nodes, a first set of nodes where each node represents a unique combination of a feature and a threshold;
assign distinct identifiers to the nodes of the first set;
identify a second set of paths included in the plurality of decision trees; and
generate an optimized model, where each path of the second set is represented using the distinct identifiers that correspond to the respective nodes along the path, and branch directions taken from the respective nodes.

16. The system of claim 15, wherein each path of the second set represents a unique path from a root node to a leaf node of a respective decision tree of the plurality of decision trees.

17. The system of claim 15, wherein determining the first set of nodes comprises:
removing one or more duplicate nodes, from the plurality of nodes, having a same feature and a same threshold as one or more other nodes of the plurality of nodes.

18. The system of claim 17, the one or more processors further to:
quantize, prior to determining the first set of nodes, the plurality of nodes to produce the one or more duplicate nodes.

19. The system of claim 15, the one or more processors further to:
encrypt the optimized model using a fully homomorphic encryption algorithm; and
transmit the encrypted, optimized model to a computing device included in an untrusted domain.

20. The system of claim 19, the one or more processors further to:
encrypt data of one or more examples using the fully homomorphic encryption algorithm;
transmit an inference request to an inference service executing on the computing device, the inference request including the encrypted data;
receive one or more encrypted scores from the inference service corresponding to the one or more examples, each of the one or more encrypted scores indicating which path of the second set to use for the respective example; and
decrypt the one or more encrypted scores to infer one or more labels corresponding to the one or more examples.
